(19) United States
(12) Patent Application Publication
(10) Pub. No.: US 2010/0124450 A1
(43) Pub. Date: May 20, 2010

(54) IMAGE FORMING APPARATUS

(76) Inventors: Shuichi NISHIDE, Ebina-shi (JP); Junichi Murakami, Ebina-shi (JP); Tetsuji Okamoto, Ebina-shi (JP); Atsushi Ogihara, Ebina-shi (JP); Atsuyuki Kitamura, Ebina-shi (JP); Masahiro Sato, Ebina-shi (JP)

Correspondence Address: MORGAN LEWIS & BOCKIUS LLP, 1111 PENNSYLVANIA AVENUE NW, WASHINGTON, DC, 20004, US

(21) Appl. No.: 12/470,034

(22) Filed: May 21, 2009

(30) Foreign Application Priority Data
Nov. 18, 2008 (JP) 2008-294446

(51) Int. Cl. G03G 15/00

(52) U.S. Cl. 399/401

(57) ABSTRACT

An image forming apparatus includes: an image carrier that rotates; a developing unit that visualizes an electrostatic latent image carried on the image carrier with a color developer into a developer image; a transfer unit that transfers the developer image carried on the image carrier to a sheet in a predetermined transfer position; a fixing unit that fixes the developer image transferred by the transfer unit to the sheet; a transport unit that transports the sheet to which the color developer image has been fixed by the fixing unit, and returns the sheet to the transfer position for transferring a developer image of another color developer to be superposed on the developer image having been fixed to the sheet; and an adjustment unit that performs adjustment to reduce a time difference between time for returning the sheet by the transport unit and time for an integer number of rotations of the image carrier.

### CROSS-REFERENCE TO RELATED APPLICATIONS

This application is based on and claims priority under 35 USC 119 from Japanese Patent Application No. 2008-294446 filed Nov. 18, 2008.

### BACKGROUND

### Technical Field

The present invention relates to an image forming apparatus.

### SUMMARY

According to an aspect of the invention, there is provided an image forming apparatus including: an image carrier that rotates; a developing unit that visualizes an electrostatic latent image carried on the image carrier with a color developer into a developer image; a transfer unit that transfers the developer image carried on the image carrier to a sheet in a predetermined transfer position; a fixing unit that fixes the developer image transferred by the transfer unit to the sheet; a transport unit that transports the sheet to which the color developer image has been fixed by the fixing unit, and returns the sheet to the transfer position for transferring a developer image of another color developer to be superposed on the developer image having been fixed to the sheet; and an adjustment unit that performs adjustment to reduce a time difference between time for returning the sheet by the transport unit and time for an integer number of rotations of the image carrier.

### BRIEF DESCRIPTION OF THE DRAWINGS

An exemplary embodiment of the present invention will be described in detail based on the following figures, wherein:

FIG. 1 is a cross-sectional view schematically showing an image forming apparatus according to an exemplary embodiment of the present invention;

FIG. 2 is a block diagram showing a configuration of a controller and its peripheral units;

FIG. 3 is a block diagram showing a structure of an adjustment program executed by a CPU 64 so as to reduce color shifts of respective color developer images overlay-transferred onto a sheet;

FIG. 4A is a graph in an example of execution of the adjustment program indicating a time difference between time for circulation of the sheet in a second transport path and time for an integer number of rotations of an image carrier when sheet contraction does not occur;

FIG. 4B is a graph showing a comparative example to FIG. 4A;

FIG. 5A is a graph schematically showing a relation between a phase of the image carrier and a length of a developer image in a sheet transport direction when sheet contraction does not occur;

FIG. 5B is a graph schematically showing the relation between the phase of the image carrier and the length of the developer image in the sheet transport direction when sheet contraction occurs;

FIG. 5C is a graph showing the result of execution of the adjustment program;

FIG. 5D is a comparative example to FIGS. 5A to 5C; and

FIG. 6 is a flowchart showing an example of the operation (S10) of the image forming apparatus upon execution of the adjustment program by the CPU 64.

### DETAILED DESCRIPTION

Next, an exemplary embodiment of the present invention will be described based on the drawings.

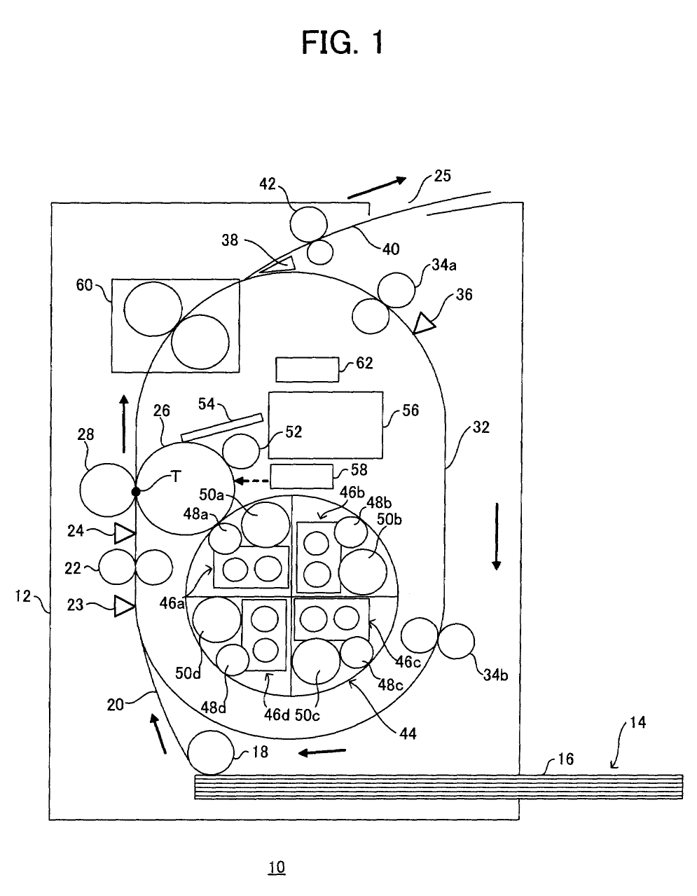

FIG. 1 schematically shows an image forming apparatus 10 according to the exemplary embodiment of the present invention. The image forming apparatus 10 has an image forming apparatus main body 12. A sheet feed unit 14 which is e.g. a one-stage unit is provided in a lower part of the image forming apparatus main body 12.

The sheet feed unit 14 has a sheet feed cassette 16 containing sheets such as print sheets. A pickup roller 18 to pick up a sheet from the sheet feed cassette 16 is provided in a position above the sheet feed cassette 16.

The pickup roller 18, driven by a driver (not shown), is rotated so as to supply a sheet toward a first transport path 20. The first transport path 20 is a sheet path from the pickup roller 18 to a registration roller 22. The first transport path 20, with a part of a second transport path 32 to be described later and a third transport path 40, forms a sheet path to an output port 25. In the sheet path, an image carrier 26 and a transfer roller 28 having an elastic surface are provided on the upstream side of a fixing device 60, and the above-described registration roller 22 is provided on the upstream side of the image carrier 26 and the transfer roller 28. A position in which the image carrier 26 and the transfer roller 28 are in contact with each other is a transfer position T in which a developer image carried on the image carrier 26 is transferred onto a sheet.

A first sensor (timing sensor) 23 for control of timing of sheet passage through the registration roller 22 is provided on the upstream side of the registration roller 22. A second sensor (exposure timing sensor) 24 for control of timing for an exposure device 58 to be described later to write an electrostatic latent image is provided on the downstream side of the registration roller 22. The first sensor 23 is an optical sensor which, upon detection of a lead edge of a sheet in a transport direction, outputs the result of detection to a controller 62 to be described later. The second sensor 24 is also an optical sensor which, upon detection of the lead edge (and a trail edge) of the sheet in the transport direction, outputs the result of detection to the controller 62.

The second transport path 32 is a circular transport path where the sheet is circulate-transported from the registration roller 22 through the transfer position T and the fixing device 60, again to the registration roller 22. Note that the second transport path 32 is provided with e.g. transport rollers 34a and 34b to transport the sheet passed through the fixing device 60 toward the registration roller 22. A third sensor (contraction amount detection sensor) 36 for calculation of a sheet contraction amount is provided on the downstream side of the transport roller 34a. The third sensor 36 is an optical sensor which detects the lead edge and the trail edge of the sheet in the transport direction and outputs the result of detection to the controller 62.

In the second transport path 32, a switching device 38 is provided on the downstream side of the fixing device 60, and a third transport path 40, branched from the second transport path 32 with the switching device 38 and is continued to the output port 25, is formed. An exit roller 42 is provided in the vicinity of the output port 25 in the third transport path 40.

Accordingly, a sheet picked up with the pickup roller 18 from the sheet feed cassette 16 of the sheet feed unit 14 is guided to the first transport path 20, and temporarily stopped with the registration roller 22 in accordance with the result of detection by the first sensor 23. Then the sheet is passed between the image carrier 26 and the transfer roller 28 at predetermined timing, and e.g. a black developer image is transferred onto the sheet. The transferred black developer image is fixed by the fixing device 60 to the sheet, and the sheet is output with the exit roller 42 from the output port 25.

Note that in the case of color printing, the switching device 38 is switched, then the sheet is circulated through the second transport path 32 while passed through the registration roller 22 four times. That is, the sheet is passed through the registration roller 22, the transfer position T and the fixing device 60 four times and is output from the output port 25.

The image forming apparatus main body 12 has a rotary developing device 44 in e.g. a lower part of an approximately central portion. The rotary developing device 44 has developing units 46a to 46d respectively containing yellow, magenta, cyan and black color developers. The developing units 46a to 46d have developing rollers 48a to 48d and removable developer containers 50a to 50d. The developing units 46a to 46d supply the developers contained in the developer containers 50a to 50d to the developing rollers 48a to 48d, and sequentially visualize an electrostatic latent image carried on the image carrier 26 with the respective color developers.

A charging device 52 having e.g. a charging roller to uniformly charge the image carrier 26 is provided on the front side of the image carrier 26. That is, a developing bias is applied to the image carrier 26. Further, an image carrier cleaner 54 is in contact with the image carrier 26 on the upstream side of the charging device 52 in a rotation direction of the image carrier 26. The image carrier cleaner 54 scrapes off developer(s) remaining on the image carrier 26 after transfer. Further, a developer collection unit 56 to collect the developer(s) scraped with the image carrier cleaner 54 is removably provided on the front side of the image carrier cleaner 54.

The exposure device 58 to write an electrostatic latent image with a light lay such as a laser beam on the image carrier 26 charged by the charging device 52 is provided between the rotary developing device 44 and the developer collection unit 56. Further, the above-described transfer roller 28 is positioned on the rear side of the image carrier 26. The transfer roller 28 sequentially overlay-transfers developer images visualized with the developing units 46a to 46d on a sheet in the transfer position T. Note that the image carrier 26 is rotated at a constant rotation speed while it transfers a one-color developer image, but in other times, the rotation speed is variably controlled by the controller 62.

The fixing device 60 is provided on the downstream side of the transfer position T. The fixing device 60, having a heating roller and a pressure roller, fixes the developer image transferred to the sheet with the image carrier 26 and the transfer roller 28 to the sheet with heat and pressure, and transports the sheet.

Further, the controller 62 to control the constituent elements of the image forming apparatus 10 is provided in the image forming apparatus main body 12.

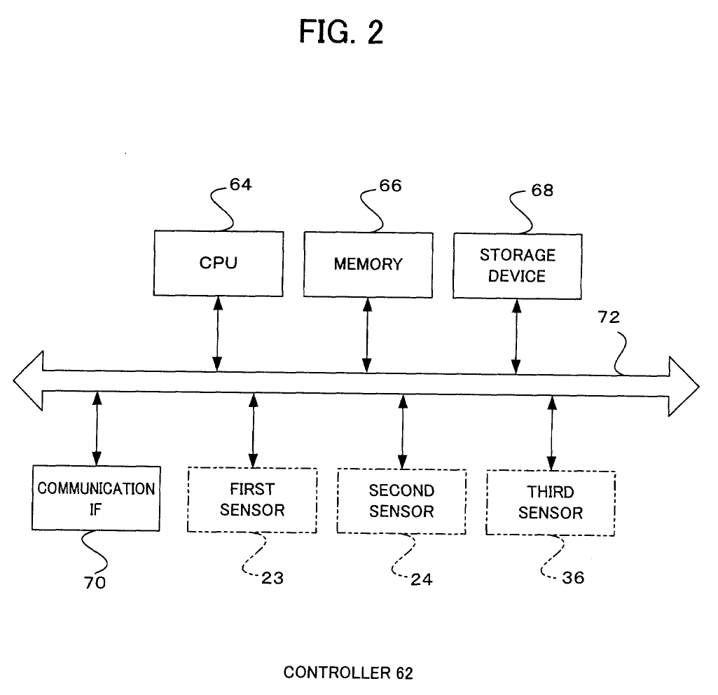

As shown in e.g. FIG. 2, the controller 62 having a CPU 64, a memory 66, a storage device 68 such as a hard disk drive (HDD) and a communication interface (IF) 70 for data transmission/reception, interconnected via a control bus 72, controls the constituent elements of the image forming apparatus 10. Note that e.g. the above-described first sensor 23, the second sensor 24 and the third sensor 36 are also connected to the control bus 72.

The CPU 64 executes predetermined processing based on a program stored in the memory 66 or the storage device 68, to control the operation of the controller 62. Further, it may be arranged such that the program is not provided from the memory 66 or the storage device 68 but is stored on a storage medium such as a CD-ROM and is provided from the storage medium. The storage medium may be a magnetic disk, a semiconductor memory or other storage media. The memory 66 holds unused (non-contracted) sizes of sheets in plural different sizes. Further, it may be arranged such that the memory 66 previously holds contracted sheet sizes, each obtained upon every passage of sheet through the fixing device 60 (every fixing of developer image), as a look-up table for sheets in plural different sizes. The communication IF 70 is used for connection with other devices.

Next, processing by the controller 62 to reduce color shifts of color developer images overlay-transferred onto a sheet will be described.

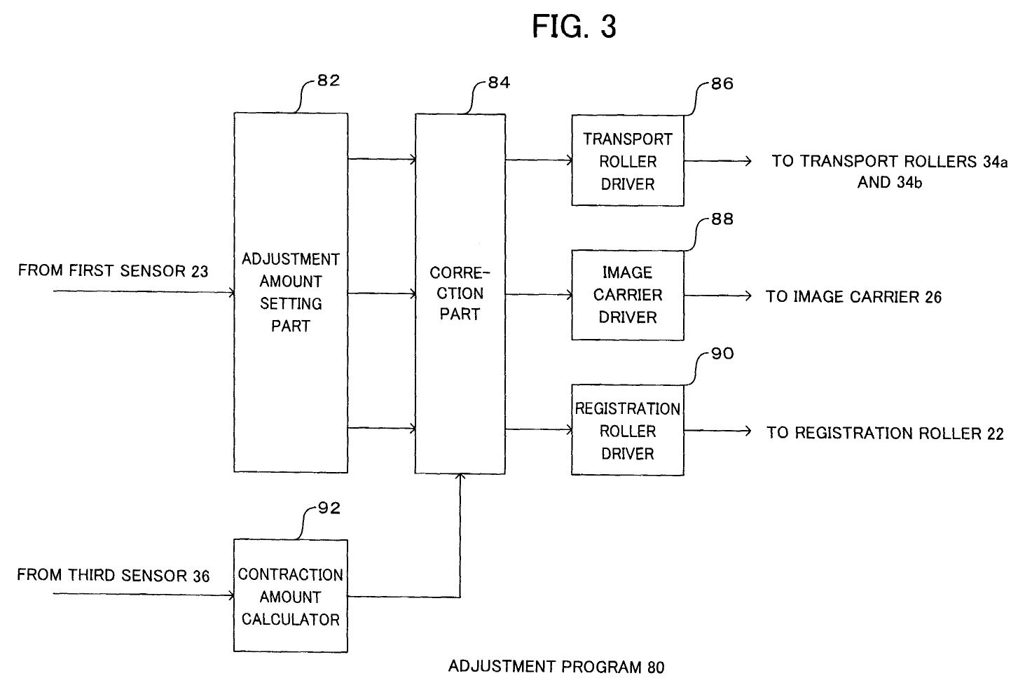

FIG. 3 is a block diagram showing a structure of an adjustment program 80 executed by the CPU 64 so as to reduce color shifts of respective color developer images overlay-transferred onto a sheet.

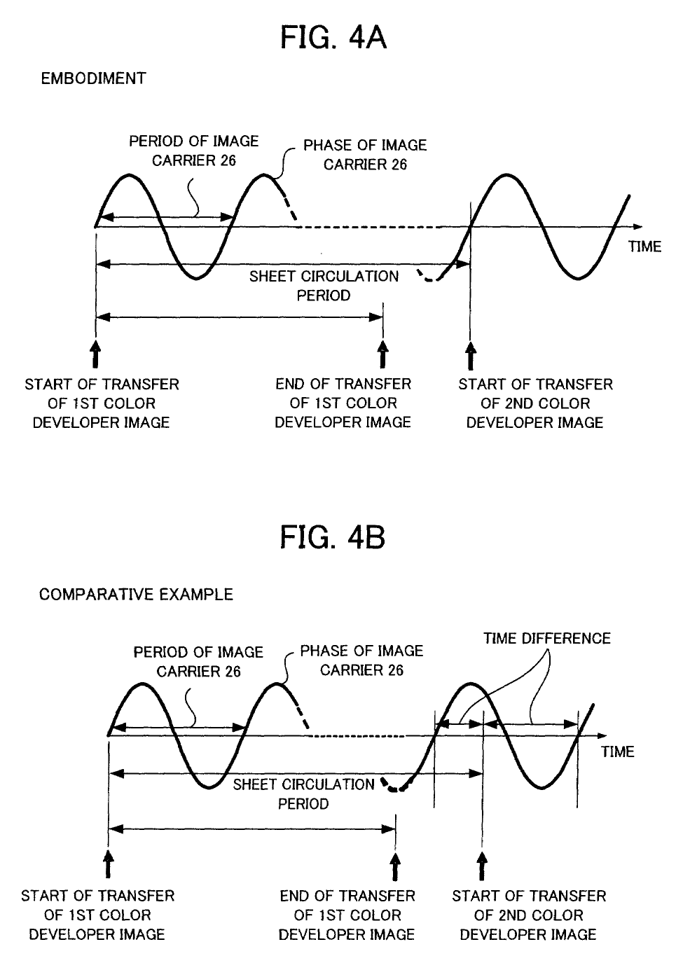

FIG. 4A is a graph in an example of execution of the adjustment program 80 indicating a time difference between time for sheet circulation in the second transport path 32 (sheet circulation period) and time for an integer number of rotations of the image carrier 26 when sheet contraction does not occur. FIG. 4B is a graph showing a comparative example to FIG. 4A.

As shown in FIG. 3, the adjustment program 80 has an adjustment amount setting part 82, a correction part 84, a transport roller driver 86, an image carrier driver 88, a registration roller driver 90 and a contraction amount calculator 92.

The adjustment amount setting part 82 receives the result of detection by the first sensor 23, and sets adjustment amounts to adjust e.g. rotation speeds (sheet transport speeds) of the transport rollers 34a and 34b, a rotation speed of the image carrier 26 and rotation start timing of the registration roller 22, for the transport roller driver 86, the image carrier driver 88 and the registration roller driver 90 via a correction part 84 to be described later, so as to reduce a time difference between time for sheet circulation in the second transport path 32 and time for an integer number of rotations of the image carrier 26.

For example, as shown in FIG. 4A, the adjustment amount setting part 82 performs setting for the image carrier driver 88 to rotate the image carrier 26 in a constant period, and performs setting for the transport roller driver 86 and the registration roller driver 90 to adjust the rotation speeds of the transport rollers 34a and 34b and the rotation start timing of the registration roller 22 such that the time for sheet circulation in the second transport path 32 and the time for the integer number of rotations of the image carrier 26 are the same. Each of the color developer images are transferred onto the sheet from the lead edge to the trail edge in the transport direction. Further, a total peripheral length of the image carrier 26 from a transfer start position of the first color developer image on the surface of the image carrier 26 to a transfer termination position of the first color developer image on the surface of the image carrier 26 after a predetermined number (not limited to an integer number) of rotations corresponds to the length of an unused (non-contracted) sheet in the transport direction.

That is, the adjustment amount setting part 82 performs setting (initial settings) for the transport roller driver 86, the image carrier driver 88 and the registration roller driver 90 so as to, when sheet contraction does not occur (transfer of the first color developer image), start transfer of the first color developer image at timing when a rotation angle of a predetermined first reference position for the lead edge of the sheet in the transport direction on the surface of the image carrier 26 is “0”, then terminate the transfer of the first color developer image at timing when a rotation angle of a second reference position for the trail edge of the sheet in the transport direction is “0”, and start transfer of the second color developer image onto the sheet which has circulated in the second transport path 32 at timing when the rotation angle of the first reference position for the lead edge of the sheet in the transport direction on the surface of the image carrier 26 is again “0” and terminate the transfer of the second color developer image at timing when the rotation angle of the second reference position for the trail edge of the sheet in the transport direction is again “0”. The first reference position and the second reference position may be set in different positions on the surface of the image carrier 26, or may be set in the same position. In the initial setting (transfer of the first color developer image) for the transport roller driver 86, the image carrier driver 88 and the registration roller driver 90, the position on the surface of the image carrier 26 (phase of the image carrier 26) for transfer of the developer image to the lead edge of the sheet in the transport direction is approximately the same as the phase of the image carrier 26 upon start of writing of an electrostatic latent image by the exposure device 58.

On the other hand, as shown in the comparative example of FIG. 4B, when the adjustment program 80 is not executed, a time difference occurs between the time for sheet circulation in the second transport path 32 and the time for the integer number of rotations of the image carrier 26. That is, as the phase of the image carrier 26 upon start of the transfer of the first color developer image and that upon start of the transfer of the second color developer image are different, a color shift occurs due to eccentricity of the image carrier 26 or the like.

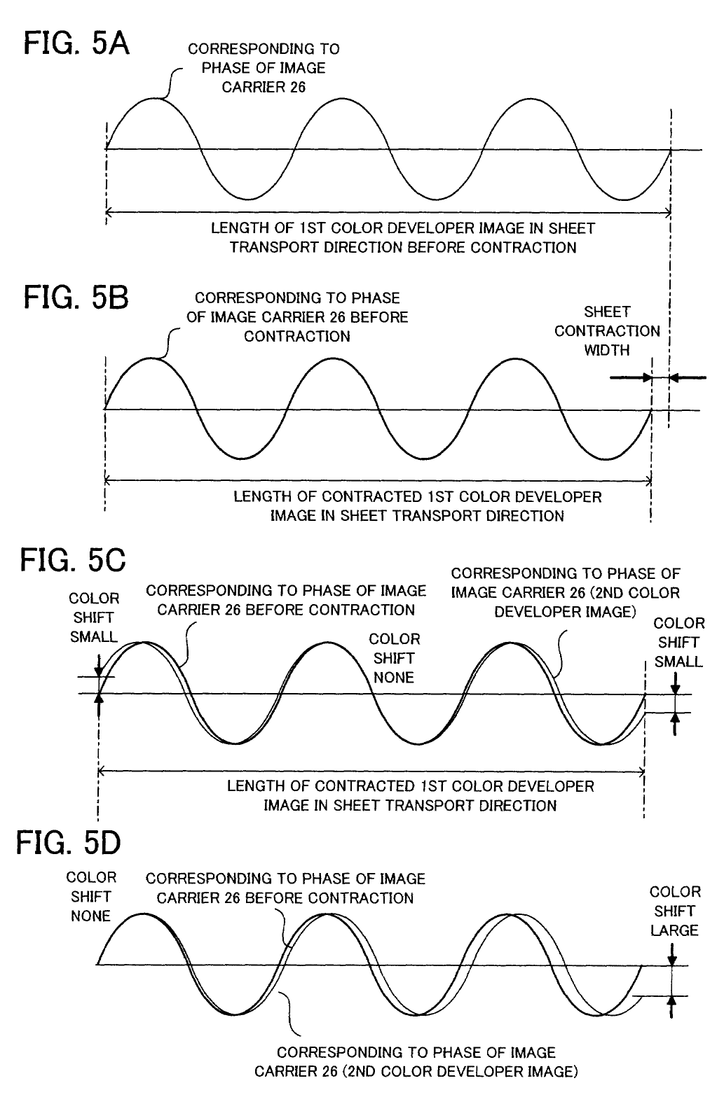

When the correction part 84 (FIG. 3) has received a sheet contraction amount from the contraction amount calculator 92 to be described later, the correction part 84 corrects outputs (settings) from the adjustment amount setting part 82 in correspondence with the sheet contraction amount (to be described later using FIGS. 5A to 5D), and performs settings after correction for the transport roller driver 86, the image carrier driver 88 and the registration roller driver 90. Note that when the correction part 84 has not received a sheet contraction amount from the contraction amount calculator 92, the correction part 84 outputs the outputs from the adjustment amount setting part 82, without correction, to the transport roller driver 86, the image carrier driver 88 and the registration roller driver 90. That is, the correction part 84 also performs determination as to whether or not the contraction amount calculator 92 has calculated and outputted a contraction amount (whether or not the transfer corresponds to the first color).

The transport roller driver 86 adjusts the rotation speeds (sheet transport speeds) of the transport rollers 34a and 34b and drives the transport rollers in correspondence with the setting received via the correction part 84. The image carrier driver 88 adjusts the rotation speed of the image carrier 26 and drives the image carrier in correspondence with the setting received via the correction part 84. Further, the image carrier driver 88 may adjust the phase of the image carrier 26 in correspondence with the result of detection of the lead edge of the sheet in the transport direction by the second sensor 24 (FIG. 1). The registration roller driver 90 adjusts the rotation start timing of the registration roller 22 and drives the registration roller in correspondence with the setting received via the correction part 84.

When the contraction amount calculator 92 has received the result of detection of the lead edge and the trail edge of the sheet in the transport direction from the third sensor 36, the contraction amount calculator 92 calculates a contraction amount with respect to a predetermined sheet length, and outputs the result of calculation to the correction part 84. For example, the contraction amount calculator 92 calculates a sheet contraction amount using a size of an unused sheet stored in the memory 66 and the result of detection by the third sensor 36. Further, the contraction amount calculator 92 may calculate a sheet contraction amount utilizing the result of detection of the lead edge and the trail edge of an unused (non-contracted) sheet in the transport direction by the second sensor 24.

FIGS. 5A to 5D show the result of execution of the adjustment program 80 by the CPU 64 with a comparative example.

FIG. 5A is a graph schematically showing relation between a phase of the image carrier 26 and a length of a developer image in the sheet transport direction when sheet contraction does not occur. FIG. 5B is a graph schematically showing the relation between the phase of the image carrier and the length of the developer image in the sheet transport direction when sheet contraction occurs. FIG. 5C is a graph showing the result of execution of the adjustment program 80. FIG. 5D is a comparative example to FIGS. 5A to 5C.

Note that the length of a developer image in the sheet transport direction (developer image forming time) corresponds to the length of a non-contracted sheet in the transport direction for the sake of simplicity of explanation of the sheet contraction, and the total peripheral length of the image carrier 26 when it has been rotated three times (three times the peripheral length of the image carrier 26) corresponds to the length of the non-contracted developer image in the sheet transport direction. That is, the figures show a case where the phase of the image carrier 26 (the predetermined first reference position for the lead edge of the sheet in the transport direction on the surface of the image carrier 26) upon start of writing of an electrostatic latent image on the image carrier 26 by the exposure device 58 and the phase of the image carrier 26 (the predetermined second reference position for the trail edge of the sheet in the transport direction on the surface of the image carrier 26) upon termination of the writing of the electrostatic latent image are the same.

Note that the length of the sheet in the transport direction and the length of the developer image in the sheet transport direction are not limited to an integer multiple of the peripheral length of the image carrier 26. For example, these lengths may be about 1.2 times of the peripheral length of the image carrier 26, or maybe about 5.8 times the peripheral length of the image carrier 26.

For example, as shown in FIG. 5A, when the length of the first color developer image in the sheet transport direction corresponds to a peripheral length for three rotations of the image carrier 26, the first color developer image transferred onto the sheet is fixed by the fixing device 60, then, when the sheet is contracted, as shown in FIG. 5B, the length of the developer image in the sheet transport direction is shortened by the sheet contraction amount.

Accordingly, the correction part 84 corrects the adjustment amounts set by the adjustment amount setting part 82 such that the difference between the distance between the lead edge of the contracted sheet in the transport direction passing through the transfer position T and the predetermined first reference position for the lead edge of the sheet in the transport direction on the surface of the image carrier 26 and the distance between the trail edge of the sheet in the transport direction passing through the transfer position T and the predetermined second reference position for the trail edge of the sheet in the transport direction on the surface of the image carrier 26 is offset in the sheet transport direction. That is, as shown in FIG. 5C, the correction part 84 allots about ½ of the shift amount to the lead edge side of the sheet and allots about ½ of the shift amount to the trail edge side of the sheet, and corrects the transfer range for the developer image to the sheet so as to prevent the color shift at an approximately central portion of the sheet. Thus the correction part 84 averages the color shift of the second color developer image with respect to the contracted first color developer image in the sheet transport direction.

Note that in FIG. 5C, in the corrected settings (transfers of the second and subsequent color developer images) for the transport roller driver 86, the image carrier driver 88 and the registration roller driver 90, the position on the surface of the image carrier 26 for transfer of developer image to the lead edge of the sheet in the transport direction (the phase of the image carrier 26 to start transfer) is different from the phase of the image carrier 26 to start writing of an electrostatic latent image by the exposure device 58.

On the other hand, as shown in the comparative example of FIG. 5D, when the phase of the image carrier 26 upon start of writing of an electrostatic latent image by the exposure device 58 on the image carrier 26 and the phase of the image carrier 26 upon termination of the writing of the electrostatic latent image are the same and the transfer of the second color developer image is started from the lead edge of the contracted sheet in the same phase as that for the transfer of the first color developer image, the color shift becomes gradually larger toward the trail edge side of the sheet.

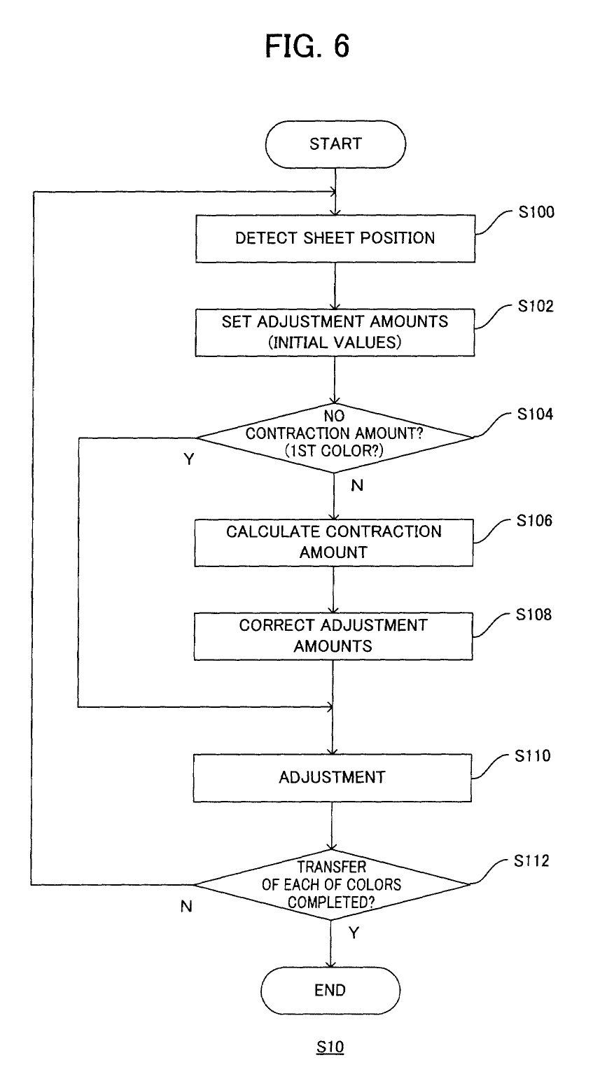

FIG. 6 is a flowchart showing an example of the operation (S10) of the image forming apparatus 10 upon execution of the adjustment program 80 by the CPU 64.

As shown in FIG. 6, at step S100, the first sensor 23 detects the lead edge of the sheet in the transport direction (sheet position) and outputs the result of detection to the controller 62.

As step S102, the adjustment amount setting part 82 receives the result of detection from the first sensor 23, and sets adjustment amounts (initial values) to adjust the rotation speeds of the transport rollers 34a and 34b, the rotation speed of the image carrier 26 and the rotation start timing of the registration roller 22.

At step S104, the correction part 84 determines whether or not the contraction amount calculator 92 has calculated and outputted a contract amount (whether or not the transfer of the first color developer image is performed). When it is determined that a sheet contraction amount has been received from the contraction amount calculator 92 (when a contraction amount has been calculated), the process proceeds to step S106, and when a sheet contraction amount has not been received from the contraction amount calculator 92 (when no contraction amount has been calculated), the process proceeds to step S110.

At step S106, the contraction amount calculator 92 calculates a sheet contraction amount in correspondence with the result of detection by the third sensor 36.

At step S108, the correction part 84 corrects the adjustment amounts set by the adjustment amount setting part 82 in correspondence with the result of calculation by the contraction amount calculator 92.

At step S110, the transport roller driver 86, the image carrier driver 88 and the registration roller driver 90 adjust the rotation speeds of the transport rollers 34a and 34b, the rotation speed of the image carrier 26 and the rotation start timing of the registration roller 22 in correspondence with the adjustment amounts received via the correction part 84.

At step S112, the controller 62 determines whether or not transfer of each of the color developer images onto the sheet has been completed. When it is determined that the transfer has not been completed, the process proceeds to step S100, and when it is determined that the transfer has been completed, the execution of the adjustment program 80 is terminated.

Next, an operation example (color printing) of the image forming apparatus 10 will be described.

When an image forming signal is sent, the image carrier 26 is uniformly charged by the charging device 52, and a light ray corresponding to a yellow image is emitted from the exposure device 58 to the charged image carrier 26 based on the image signal. The light ray from the exposure device 58 exposes the surface of the image carrier 26, thereby an electrostatic latent image is formed.

The electrostatic latent image carried on the image carrier 26 is developed with the yellow developer supplied to the developing roller 48a of the developing unit 46a, and is transferred to a sheet supplied from the sheet feed unit 14. The sheet to which the yellow developer image has been transferred is guided to the fixing device 60, and the developer image is fixed to the sheet with the heating roller and the pressure roller.

Note that the sheet to which the yellow developer image has been fixed is guided with the switching device 38 toward the transport rollers 34a and 34b. The speed of circulation of the sheet transported with the transport rollers 34a, and 34b in the second transport path 32 is controlled by the controller 62.

The developer remaining on the image carrier 26 is scraped off by the image carrier cleaner 54, and collected into the developer collection unit 56.

Then the image carrier 26 is uniformly charged again by the charging device 52, and a light ray corresponding to a magenta image is emitted from the exposure device 58 to the charged image carrier 26 based on the image signal. The light ray from the exposure device 58 exposes the surface of the image carrier 26, thereby an electrostatic latent image is formed.

The electrostatic latent image carried on the image carrier 26 is developed with the magenta developer supplied to the developing roller 48b of the developing unit 46b, then transported with transport rollers 34a and 34b under the control of the controller 62, and overlay-transferred to the sheet timing-controlled with the registration roller 22.

The sheet to which the magenta developer image has been transferred is guided to the fixing device 60, and the developer image is fixed to the sheet with the heating roller and the pressure roller. The sheet to which the magenta developer image has been fixed is guided with the switching device 38 toward the transport rollers 34a and 34b. The developer remaining on the image carrier 26 is scraped off by image carrier cleaner 54 and is collected into the developer collection unit 56.

As the sheet is returned toward the transport rollers 34a and 34b three times, as in the case of the yellow and magenta developer images, developer images developed with the cyan and the black developers are fixed to the sheet by the fixing device 60. Thus a color image is formed with overlaid developer images on the sheet. The sheet to which the color image has been fixed is guided with the switching device 38 to the exit roller 42 and output.

Note that in the above-described exemplary embodiment, the sheet contraction amount is obtained by calculation in correspondence with the result of detection by the third sensor 36; however, the present invention is not limited to this arrangement. For example, it may be arranged such that a previously measured sheet contraction is stored by condition (including the number of fixings, a sheet size, an environmental condition and the like) in storage device 68 or stored as a look-up table in the memory 66, then the CPU 64 as a contraction amount acquisition unit obtains the contraction amount stored in the storage device 68 or the memory 66, and the correction part 84 corrects the outputs (settings) from the adjustment amount setting part 82 in correspondence with the sheet contraction amount. Further, it maybe arranged such that the adjustment amount setting part 82 sets the adjustment amounts such that the time for sheet circulation in the second transport path 32 and the time for the integer number of rotations of the image carrier 26 are the same by changing the rotation speed (rotation period) of the image carrier 26 when a developer image is not transferred.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image carrier that rotates;
a developing unit that visualizes an electrostatic latent image carried on the image carrier with a color developer into a developer image;
a transfer unit that transfers the developer image carried on the image carrier to a sheet in a predetermined transfer position;
a fixing unit that fixes the developer image transferred by the transfer unit to the sheet;
a transport unit that transports the sheet to which the color developer image has been fixed by the fixing unit, and returns the sheet to the transfer position for transferring a developer image of another color developer to be superposed on the developer image having been fixed to the sheet; and
an adjustment unit that performs adjustment to reduce a time difference between time for returning the sheet by the transport unit and time for an integer number of rotations of the image carrier.

2. The image forming apparatus according to claim 1, wherein the adjustment unit performs adjustment to reduce the time difference by changing the time for returning the sheet by the transport unit.

3. The image forming apparatus according to claim 1, wherein the adjustment unit performs adjustment to reduce the time difference by changing a rotation period of the image carrier while the transfer unit does not transfer the developer image.

4. The image forming apparatus according to claim 2, wherein the adjustment unit performs adjustment to reduce the time difference by changing a rotation period of the image carrier while the transfer unit does not transfer the developer image.

5. The image forming apparatus according to claim 1, further comprising:
a contraction amount acquisition unit that acquires a contraction amount of the sheet by the fixing of the developer image by the fixing unit; and
a correction unit that corrects an adjustment amount by the adjustment unit based on the contraction amount of the sheet acquired by the contraction amount acquisition unit.

6. The image forming apparatus according to claim 2, further comprising:
a contraction amount acquisition unit that acquires a contraction amount of the sheet by the fixing of the developer image by the fixing unit; and
a correction unit that corrects an adjustment amount by the adjustment unit based on the contraction amount of the sheet acquired by the contraction amount acquisition unit.

7. The image forming apparatus according to claim 3, further comprising:
a contraction amount acquisition unit that acquires a contraction amount of the sheet by the fixing of the developer image by the fixing unit; and
a correction unit that corrects an adjustment amount by the adjustment unit based on the contraction amount of the sheet acquired by the contraction amount acquisition unit.

8. The image forming apparatus according to claim 4, further comprising:
a contraction amount acquisition unit that acquires a contraction amount of the sheet by the fixing of the developer image by the fixing unit; and
a correction unit that corrects an adjustment amount by the adjustment unit based on the contraction amount of the sheet acquired by the contraction amount acquisition unit.

9. The image forming apparatus according to claim 5, wherein the correction unit corrects the adjustment amount by the adjustment unit so as to offset a difference between a distance between a lead edge of the sheet passing through the transfer position in a transport direction and a first reference position for the lead edge of the sheet in the transport direction on a surface of the image carrier and a distance between a trail edge of the sheet passing through the transfer position in the transport direction and a second reference position for the trail edge of the sheet in the transport direction on the surface of the image carrier in a sheet transport direction.

10. The image forming apparatus according to claim 6, wherein the correction unit corrects the adjustment amount by the adjustment unit so as to offset a difference between a distance between a lead edge of the sheet passing through the transfer position in a transport direction and a first reference position for the lead edge of the sheet in the transport direction on a surface of the image carrier and a distance between a trail edge of the sheet passing through the transfer position in the transport direction and a second reference position for the trail edge of the sheet in the transport direction on the surface of the image carrier in a sheet transport direction.

11. The image forming apparatus according to claim 7, wherein the correction unit corrects the adjustment amount by the adjustment unit so as to offset a difference between a distance between a lead edge of the sheet passing through the transfer position in a transport direction and a first reference position for the lead edge of the sheet in the transport direction on a surface of the image carrier and a distance between a trail edge of the sheet passing through the transfer position in the transport direction and a second reference position for the trail edge of the sheet in the transport direction on the surface of the image carrier in a sheet transport direction.

12. The image forming apparatus according to claim 8, wherein the correction unit corrects the adjustment amount by the adjustment unit so as to offset a difference between a distance between a lead edge of the sheet passing through the transfer position in a transport direction and a first reference position for the lead edge of the sheet in the transport direction on a surface of the image carrier and a distance between a trail edge of the sheet passing through the transfer position in the transport direction and a second reference position for the trail edge of the sheet in the transport direction on the surface of the image carrier in a sheet transport direction.
